(19) United States
(12) Patent Application Publication
(10) Pub. No.: US 2016/0342613 A1
(43) Pub. Date: Nov. 24, 2016

(54) DISPLAY DEVICE AND IMAGE FORMING APPARATUS

(71) Applicant: KYOCERA Document Solutions Inc., Osaka (JP)

(72) Inventor: Seiji ONISHI, Osaka-shi (JP)

(73) Assignee: KYOCERA Document Solutions Inc., Osaka (JP)

(21) Appl. No.: 15/158,962

(22) Filed: May 19, 2016

(30) Foreign Application Priority Data
May 22, 2015 (JP) 2015-104507

(51) Int. Cl. G06F 17/30; H04N 1/00; G06F 3/0486; G06F 3/0482; G06F 3/0488; G06F 3/041; G06F 3/0484

(52) U.S. Cl. CPC G06F 17/30126; G06F 3/0412; H04N 1/00411; H04N 1/00442; G06F 3/04842; G06F 3/0482; G06F 3/0488; G06F 3/0486; H04N 2201/0094

(57) ABSTRACT

A display device includes a display section, a controller, and a touch panel. The display section has a display surface. The controller allocates, on the display surface, a plurality of file selection areas in one-to-one correspondence with a plurality of files. The touch panel detects a position of a touch on the display surface. The controller selects two or more of the plurality of files corresponding to two or more of the plurality of file selection areas through which the touch has traveled after a specific input is detected.

### INCORPORATION BY REFERENCE

The present application claims priority under 35 U.S.C. §119 to Japanese Patent Application No. 2015-104507, filed on May 22, 2015. The contents of this application are incorporated herein by reference in their entirety.

### BACKGROUND

The present disclosure relates to display devices and image forming apparatuses.

Some digital video players include a selection button and a thumbnail display section for displaying thumbnails of a plurality of files. One example of digital video players allows a plurality of thumbnails to be continuously selected through a selection button being pressed and held longer than a specific period of time.

### SUMMARY

A display device according to a first aspect of the present disclosure includes a display section, a controller, and a detection section. The display section has a display surface. The controller allocates, on the display surface, a plurality of file selection areas in one-to-one correspondence with a plurality of files. The detection section detects a position of a touch on the display surface. The controller selects two or more of the plurality of files corresponding to two or more of the plurality of file selection areas through which the touch has traveled after a specific input is detected.

An image forming apparatus according to a second aspect of the present disclosure includes the display device according to the first aspect of the present disclosure and an image forming section. The image forming section forms an image on a sheet based on the two or more selected files.

### BRIEF DESCRIPTION OF THE DRAWINGS

FIG. 1 illustrates a display device according to a first embodiment of the present disclosure.

FIG. 2A illustrates an initial state of the display device according to the first embodiment of the present disclosure.

FIG. 2B illustrates thumbnail display control that is performed by the display device according to the first embodiment of the present disclosure during a normal selection mode.

FIG. 3A illustrates a first half of thumbnail display change control that is performed by the display device according to the first embodiment of the present disclosure during the normal selection mode.

FIG. 3B illustrates a last half of the thumbnail display change control that is performed by the display device according to the first embodiment of the present disclosure during the normal selection mode.

FIG. 4A illustrates continuous selection control that is performed by the display device according to the first embodiment of the present disclosure during a continuous selection mode.

FIG. 4B illustrates thumbnail display change control that is performed by the display device according to the first embodiment of the present disclosure during the continuous selection mode.

FIG. 5 is a flowchart illustrating the continuous selection control that is performed by the display device according to the first embodiment of the present disclosure.

FIG. 6 is a schematic cross-sectional view illustrating an image forming apparatus according to a second embodiment of the present disclosure.

### DETAILED DESCRIPTION

The following describes embodiments of the present disclosure with reference to the accompanying drawings. Elements in the drawings that are the same or equivalent are marked by the same reference signs, and description of such elements is not repeated.

### First Embodiment

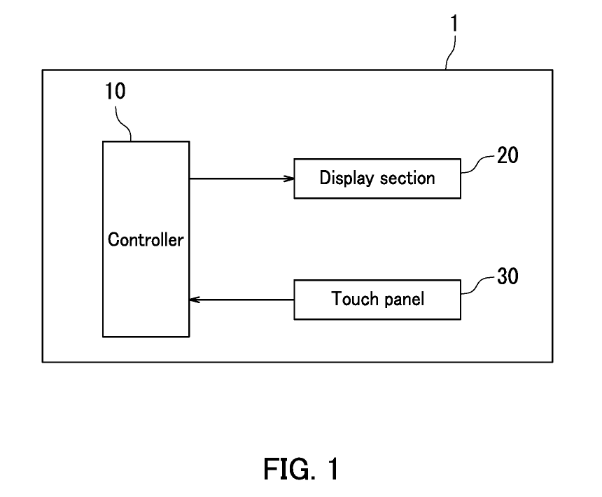

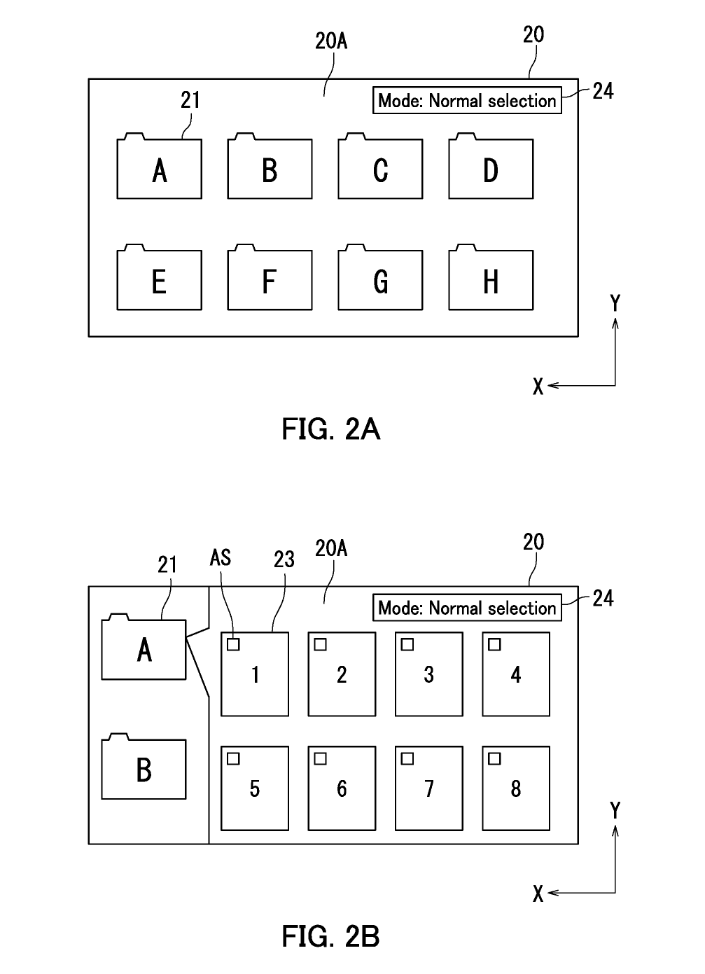

The following describes a display device 1 according to a first embodiment of the present disclosure with reference to FIGS. 1 and 2A. FIG. 1 illustrates the display device 1. FIG. 2A illustrates an initial state of the display device 1 that performs thumbnail display control. The display device 1 includes a controller 10, a display section 20, and a touch panel 30 serving as a detection section.

The display section 20 displays an image. The display section 20 is for example a liquid-crystal display. The display section 20 has a display surface 20A. In FIG. 2A, an X axis is parallel to long sides of the display surface 20A of the display section 20, and a Y axis is parallel to short sides of the display surface 20A of the display section 20.

The touch panel 30 detects a position of a touch on the display surface 20A of the display section 20. The touch panel 30 also measures a period of time of a touch on the display surface 20A of the display section 20. In the present specification, a user for example operates the touch panel 30 with one finger.

The controller 10 has a normal selection mode and a continuous selection mode. During the normal selection mode, the user selects a plurality of files one by one. On the other hand, during the continuous selection mode, the user selects a plurality of files continuously. The following describes the normal selection mode and the continuous selection mode in detail.

First, the normal selection mode will be described in detail with reference to

FIGS. 1 to 3B. FIG. 2B illustrates thumbnail display control that is performed by the display device 1 during the normal selection mode. The controller 10 is in the normal selection mode while the display device 1 is in the initial state. As illustrated in FIG 2A, the controller 10 allocates a folder selection area 21 on the display surface 20A of the display section 20 while the display device 1 is in the initial state. The folder selection area 21 corresponds to a folder. The folder is for example acquired from a storage section (not shown) of the display device 1. Alternatively, the folder may be acquired from an external device. An image representing the folder corresponding to the folder selection area 21 is displayed in a region of the display section 20 that corresponds to the folder selection area 21. The image representing the folder is for example an icon.

In the present embodiment, folders A to H are acquired. Accordingly, eight folder selection areas 21 allocated on the display surface 20A are one-to-one correspondence with the folders A to H. The folder selection area 21 allocated at the upper left of the display surface 20A corresponds to the folder A. A region of the display section 20 that corresponds to the folder selection area 21 allocated at the upper left of the display surface 20A therefore displays an image representing the folder A. Likewise, regions of the display section 20 that respectively correspond to the other folder selection areas 21 display images representing the folders B to H.

Upon the touch panel 30 detecting a touch within any of the folder selection areas 21, the controller 10 selects the folder corresponding to the folder selection area 21 at a position of the touch detected. For example, in a situation in which the touch panel 30 has detected a touch at a position of the folder selection area 21 corresponding to the folder A, the controller 10 selects the folder A.

Upon the folder being selected, as illustrated in FIG. 2B, the controller 10 allocates file selection areas AS on the display surface 20A of the display section 20. One or more files are stored in the folder. The files are for example data files or image files. The file selection areas AS are in one-to-one correspondence with the files stored in the selected folder. Regions of the display section 20 that correspond to the file selection areas AS for example each display a check box. That is, the check boxes displayed on the display section 20 are one-to-one correspondence with the files stored in the selected folder.

In the present embodiment, files 1 to 8 are stored in the folder A. The controller 10 allocates eight file selection areas AS on the display surface 20A. More specifically, on the display surface 20A, four file selection areas AS are allocated and arranged in a row from the upper left of the display surface 20A to the upper right of the display surface 20A. Furthermore, on the display surface 20A, a file selection area AS next to the file selection area AS located at the upper right of the display surface 20A is allocated at the lower left of the display surface 20A. Furthermore, on the display surface 20A, four file selection areas AS are allocated and arranged in a row from the lower left of the display surface 20A to the lower right of the display surface 20A.

The user can set up the order of the plurality of files corresponding to the respective file selection areas AS. For example, the user associates the files with the file selection areas AS, respectively, in order of file names. In the present embodiment, the files 1 to 8 stored in the selected folder A are respectively associated with the eight file selection areas AS in order of file names

The controller 10 causes the display section 20 to display thumbnails 23 of the files corresponding to the file selection areas AS such that each of the thumbnails 23 is superimposed on a region of the display section 20 that corresponds to each of the file selection areas AS. In the present embodiment, the file selection area AS allocated at the upper left of the display surface 20A corresponds to the file 1. The controller 10 therefore causes the display section 20 to display the thumbnail 23 of the file 1 such that the thumbnail 23 is superimposed on a region of the display section 20 that corresponds to the file selection area AS allocated at the upper left of the display surface 20A. Likewise, the controller 10 causes the display section 20 to display the thumbnails 23 of the files 2 to 8.

Upon the touch panel 30 detecting a touch at a position of any of the file selection areas AS during the normal selection mode, the controller 10 selects the file corresponding to the file selection area AS at the position of the touch detected. For example, upon the touch panel 30 detecting a touch within the file selection area AS allocated at the upper left of the display surface 20A, the controller 10 selects the file 1. During the normal selection mode, the user selects a plurality of files by sequentially touching a plurality of file selection areas AS on the display surface 20A that correspond to the respective files to be selected.

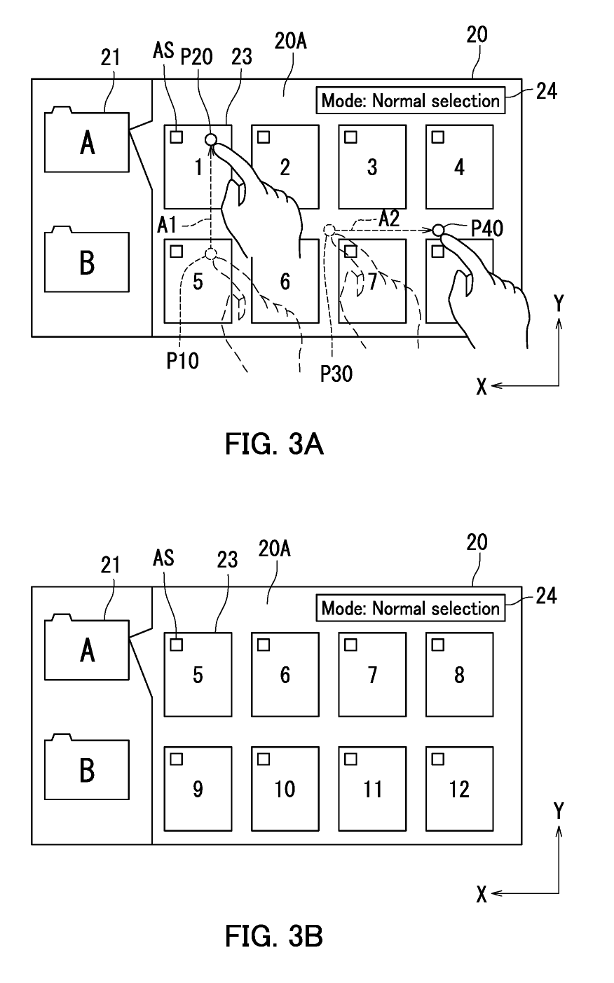

FIG. 3A illustrates a first half of thumbnail display change control that is performed by the display device 1 in the normal selection mode. FIG. 3B illustrates a last half of the thumbnail display change control that is performed by the display device 1 during the normal selection mode. Upon a touch traveling in a specific direction being detected on the display surface 20A during the normal selection mode as illustrated in FIG. 3A, the controller 10 changes the files corresponding to the respective file selection areas AS.

A touch is determined to be traveling in the specific direction for example when the controller 10 determines that the touch is traveling along the Y axis. More specifically, for example, when a touch is traveling along the Y axis within a region of the display surface 20A that corresponds to one thumbnail 23, the controller 10 determines that the touch is traveling along the Y axis. For another example, when a touch is traveling from a region of the display surface 20A that corresponds to one thumbnail 23 to a region of the display surface 20A that corresponds to another thumbnail 23 among a plurality of thumbnails 23 displayed in the same column along the Y axis, the controller 10 determines that the touch is traveling along the Y axis. A user can set up any definition for the specific direction.

When a touch traveling in the specific direction is heading in a positive direction of the Y axis, the controller 10 changes the files corresponding to the respective file selection areas AS to other files that are closer to the end of the file order set up by the user. On the other hand, when a touch traveling in the specific direction is heading in a negative direction of the Y axis, the controller 10 changes the files corresponding to the respective file selection areas AS to other files that are closer to the top of the file order set up by the user.

In the present embodiment, the touch panel 30 for example detects a touch traveling from a point P10 within a region of the display surface 20A that corresponds to the thumbnail 23 of the file 5 to a point P20 within a region of the display surface 20A that corresponds to the thumbnail 23 of the file 1 as indicated by arrow A1. The file 5 and the file 1 are displayed in the same column along the Y axis on the display section 20. In this case, the controller 10 determines that the touch traveling as indicated by arrow A1 is traveling in the specific direction and heading in the positive direction of the Y axis. As a result, the controller 10 changes the files corresponding to the respective file selection areas AS to the files that are closer to the end of the file order set up by the user as illustrated in FIG. 3B. The display section 20 displays the thumbnails 23 of the files that are closer to the end of the file order.

The following describes the thumbnail display change control that is performed by the display device 1 during the normal selection mode using a specific example. In the specific example, the display surface 20A includes eight file selection areas AS. The eight file selection areas AS are in one-to-one correspondence with the files 1 to 8. Files 1 to 12 are stored in the storage section of the display device 1. A user associates the files 1 to 12 with a plurality of file selection areas AS, respectively, in order of file names.

First, the touch panel 30 detects a touch traveling in the specific direction and heading in the positive direction of the Y axis as indicated by arrow A1 on the display surface 20A. In response, the controller 10 changes the files 1 to 8 corresponding to the respective file selection areas AS to the files 5 to 12 that are closer to the end of the file order set up by the user. The controller 10 also causes the display section 20 to display thumbnails 23 of the files 5 to 12 such that each of the thumbnails 23 is superimposed on a corresponding one of the file selection areas AS.

On the other hand, when the touch panel 30 detects a touch traveling in a direction intersecting with the specific direction on the display surface 20A during the normal selection mode as illustrated in FIG. 3A, the controller 10 allocates folder selection areas 21 on the display surface 20A. A touch is determined to be traveling in the direction intersecting with the specific direction for example when the controller 10 determines that the touch is traveling along the X axis. More specifically, for example, when a touch is traveling from a region of the display surface 20A that corresponds to one thumbnail 23 to a region of the display surface 20A that corresponds to another thumbnail 23 among a plurality of thumbnails 23 displayed in the same row, which is not along the Y axis, the controller 10 determines that the touch is traveling along the X axis. Alternatively, the controller 10 may determine that a touch is traveling in the direction intersecting with the specific direction based on a determination that the detected touch traveling within the display surface 20A is not traveling along the Y axis. A user can set up any definition for the direction intersecting with the specific direction.

In the present embodiment, the touch panel 30 for example detects a touch traveling from a point P30 to a point P40 as indicated by arrow A2. Arrows A2 and A1 intersect with one another assuming that arrow A2 is extended in the positive direction of the X axis. The controller 10 therefore determines that the touch traveling as indicated by arrow A2 is traveling in the direction intersecting with the specific direction. As a result, the controller 10 allocates folder selection areas 21 on the display surface 20A and displays images representing folders in regions of the display section 20 that correspond to the respective folder selection areas 21. More specifically, as illustrated in FIG. 2A, the controller 10 allocates the folder selection areas 21 corresponding to the folders A to H, respectively, on the display surface 20A and causes the display section 20 to display the images representing the folders in association with the folder selection areas 21.

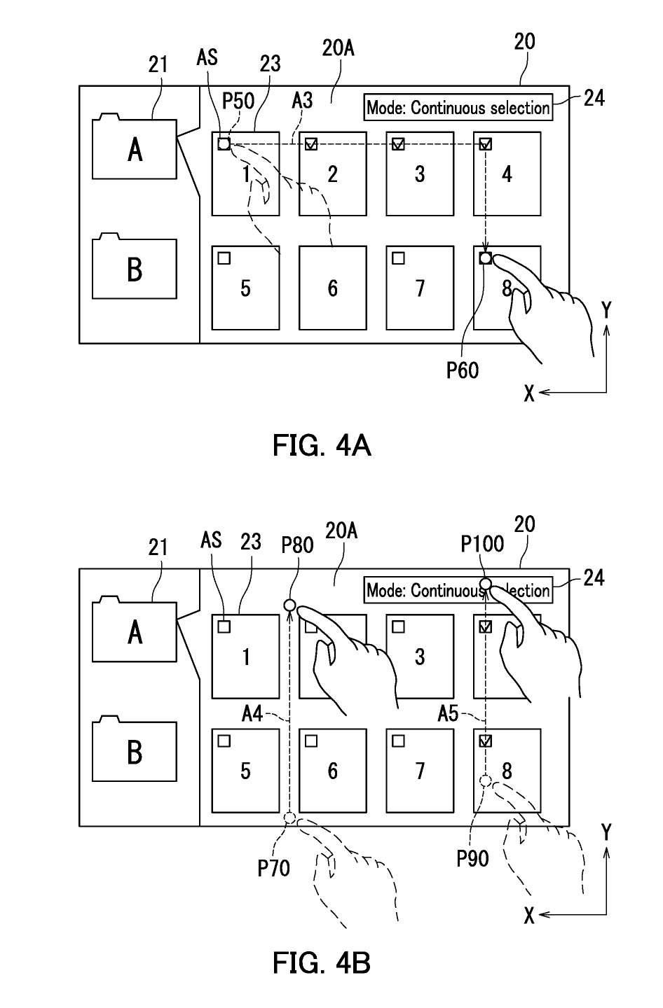

The following describes the continuous selection mode in detail with reference to FIGS. 1, 4A and 4B. FIG. 4A illustrates continuous selection control that is performed by the display device 1 during the continuous selection mode. The continuous selection control refers to control of continuous selection of a plurality of files through a user's swipe on the display surface 20A. The controller 10 switches between the modes in response to detection of a specific input.

The specific input for example refers to a touch detected by the touch panel 30 within a mode selection area 24. The controller 10 further allocates the mode selection area 24 on the display surface 20A. The controller 10 switches from the normal selection mode to the continuous selection mode in response to the touch panel 30 detecting a touch within the mode selection area 24. An image representing a currently selected mode is displayed at a position on the display section 20 that corresponds to the mode selection area 24. The user can therefore recognize the currently selected mode by viewing the display section 20.

Alternatively, the specific input may for example refer to a touch that is detected by the touch panel 30 within a file selection area AS and that is stationary for at least a specific period of time. That is, the controller 10 switches from the normal selection mode to the continuous selection mode in response to the touch panel 30 detecting a touch that is stationary for at least a specific period of time within a file selection area AS. The user can set up any period as the specific period of time. In a configuration in which the specific period of time is two seconds, for example, the controller 10 switches from the normal selection mode to the continuous selection mode in response to detection of a touch that is stationary for at least two seconds within a file selection area AS.

During the continuous selection mode, the controller 10 selects a plurality of files corresponding to file selection areas AS through which a touch has traveled. The controller 10 causes the display section 20 to accentuate the check boxes corresponding to the selected files. For example, the controller 10 causes the display section 20 to display check marks in the respective check boxes corresponding to the selected files. The user can recognize which files have been selected by viewing the check marks. Alternatively or additionally, the controller 10 may change the color of the check boxes or shade the thumbnails 23 of the selected files in order for the user to recognize which files have been selected. The user deselects a selected file by for example touching a point within the file selection area AS corresponding to the selected file.

In the present embodiment, the touch panel 30 for example detects a touch traveling from a point P50 to a point P60 as indicated by arrow A3. More specifically, the touch panel 30 detects a touch traveling through the file selection areas AS corresponding to the file 1, the file 2, the file 3, the file 4, and the file 8, respectively. The controller 10 therefore selects the file 1, the file 2, the file 3, the file 4, and the file 8, and accentuates the check boxes corresponding to the file 1, the file 2, the file 3, the file 4, and the file 8, respectively. In the present embodiment, check marks are displayed in the check boxes corresponding to the file 1, the file 2, the file 3, the file 4, and the file 8, respectively.

FIG. 4B illustrates thumbnail display change control that is performed by the display device 1 during the continuous selection mode. Upon the touch panel 30 detecting a touch traveling without passing through any of the file selection areas AS within the display surface 20A during the continuous selection mode, the controller 10 changes the files corresponding to the respective file selection areas AS in the same manner as in the normal selection mode.

Upon the touch panel 30 detecting a touch traveling through any of the file selection areas AS within the display surface 20A during the continuous selection mode, the controller 10 maintains the files corresponding to the respective file selection areas AS. That is, upon a user's swipe on the display surface 20A passing through one or more of the file selection areas AS during the continuous selection mode, the files corresponding to the respective file selection areas AS are not changed, and the thumbnails 23 displayed on the display section 20 are not changed. Therefore, the displayed by the display section 20 are not changed upon a user's swipe on the display surface 20A passing through one or more of the file selection areas AS during the continuous selection mode.

In the present embodiment, the touch panel 30 for example detects a touch traveling from a point P70 to a point P80 as indicated by arrow A4. Arrow A4 does not pass through any of the file selection areas AS. The files corresponding to the respective file selection areas AS are therefore changed. For another example, the touch panel 30 detects a touch traveling from a point P90 to a point P100 as indicated by arrow A5. Arrow AS passes through two file selection areas AS. The files corresponding to the respective file selection areas AS are therefore maintained, and the files 4 and 8 are selected.

The controller 10 switches from the continuous selection mode to the normal selection mode in response to detection of a touch that is stationary within a file selection area AS for at least a specific period of time. Alternatively, the controller 10 may switch from the continuous selection mode to the normal selection mode in response to detection of a touch within the mode selection area 24. In a situation in which a user performs a swipe within a file selection area AS and then releases the touch on the display surface 20A during the continuous selection mode, the continuous selection mode may be maintained or may be switched to the normal selection mode.

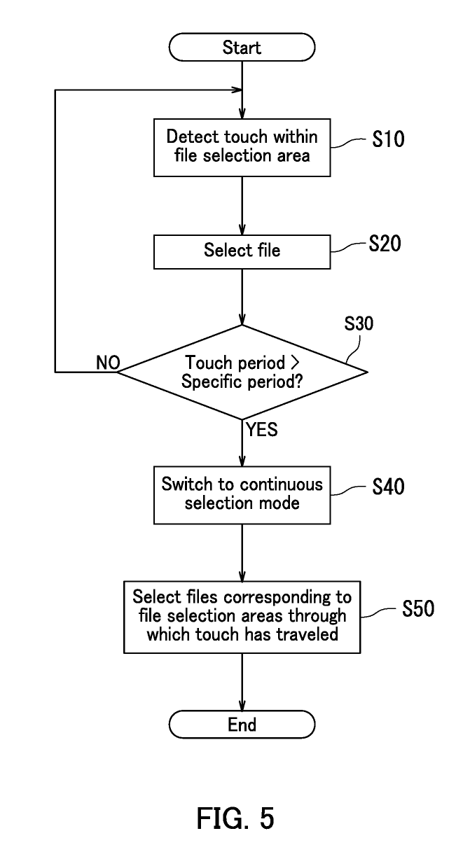

The following describes a continuous selection control method that is implemented by the display device 1 with reference to FIGS. 1 to 5. FIG. 5 is a flowchart illustrating the continuous selection control method. In the continuous selection control method, a plurality of files are selected through Steps S10 to S50. The following provides detailed description. The controller 10 initially selects the normal selection mode.

In Step S10, the touch panel 30 detects a touch within a file selection area AS. In step S20, the controller 10 selects a file corresponding to the file selection area AS at a position of the touch detected.

In Step S30, the controller 10 determines whether or not a period of time during which the detected touch is stationary, that is, a period of time of the touch on the display surface 20A by a user without moving a finger has exceeded a specific period of time. When a result of the determination is negative (No) in Step S30, the process returns to Step S10. That is, the normal selection mode is maintained unless the period of time of the touch on the display surface 20A by the user without moving the finger has exceeded the specific period of time. When the result of the determination is positive (Yes) in Step S30, the process proceeds to Step S40. In Step S40, the controller 10 switches from the normal selection mode to the continuous selection mode.

In step S50, the controller 10 sequentially selects files corresponding to the file selection areas AS through which the touch detected by the touch panel 30 has traveled. That is, the user continuously selects a plurality of files through a swipe on the corresponding check boxes displayed on the display surface 20A.

According to the first embodiment, as described above with reference to FIGS. 1 to 5, the normal selection mode is switched to the continuous selection mode upon detection of a touch that is stationary within a file selection area AS for at least the specific period of time. The user can therefore switch the mode to the continuous selection mode only by touching the display surface 20A of the display section 20. Thus, the user can put the files under the continuous selection mode with a simple operation.

According to the first embodiment, files corresponding to file selection areas AS through which a touch has traveled are selected after detection of a touch that is stationary within a file selection area AS for at least the specific period of time, that is, during the continuous selection mode. The user can therefore select a plurality of files by moving a finger on the display surface 20A. Thus, the user can select a plurality of files with a simple operation.

According to the first embodiment, a plurality of files corresponding to a plurality of file selection areas AS are maintained when a touch is traveling through one or more of the file selection areas AS within the display surface 20A during the continuous selection mode. The user can therefore select a plurality of files by moving a finger on the display surface 20A while maintaining the plurality of files corresponding to the respective file selection areas AS during the continuous selection mode. Thus, the user can select a plurality of files with a simpler operation.

According to the first embodiment, a plurality of files corresponding to a plurality of file selection areas AS are changed when a touch is traveling without passing through any of the file selection areas AS within the display surface 20A during the continuous selection mode. The user can therefore select other files by moving a finger on the display surface 20A during the continuous selection mode. Thus, the user can select a plurality of files with a simpler operation.

### Second Embodiment

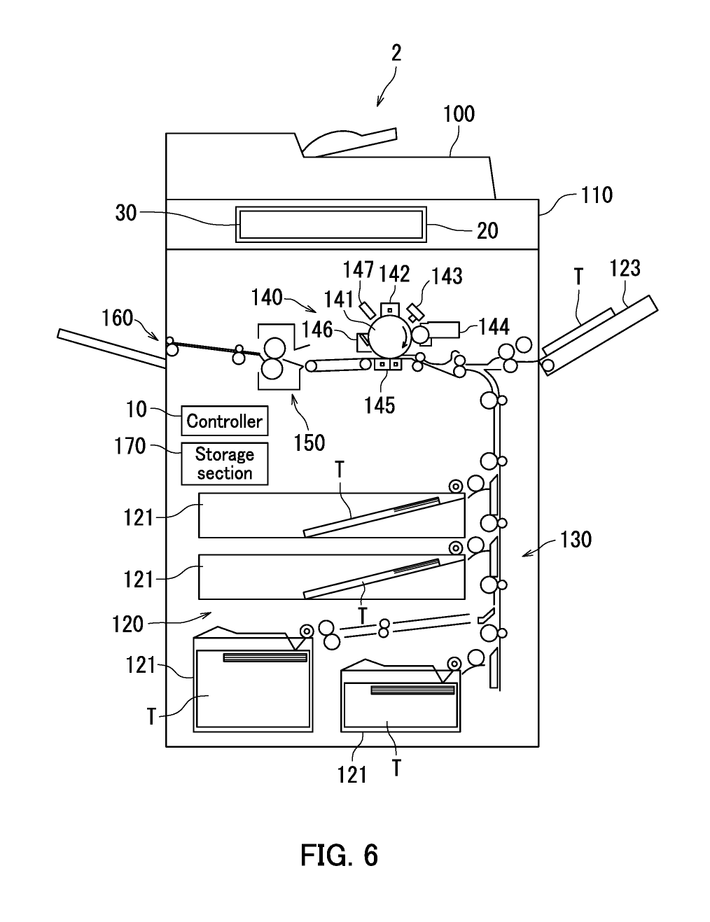

The following describes an image forming apparatus 2 according to a second embodiment of the present disclosure with reference to FIG. 6. FIG. 6 illustrates an image forming apparatus 2. The image forming apparatus 2 is for example a copier, a printer, a facsimile machine, or a multifunction peripheral. The multifunction peripheral for example includes at least two of a copier, a printer, and a facsimile machine.

The image forming apparatus 2 includes the controller 10, a document conveyance section 100, an image reading section 110, an accommodation section 120, a conveyance section 130, an image forming section 140, a fixing section 150, an ejecting section 160, and a storage section 170 for storing a plurality of files. A sheet T is conveyed within the image forming apparatus 2 in a sheet conveyance direction.

The controller 10 of the image forming apparatus 2 functions as the controller 10 according to the first embodiment. The display section 20 of the image forming apparatus 2 functions as the display section 20 according to the first embodiment. The touch panel 30 of the image forming apparatus 2 functions as the touch panel 30 according to the first embodiment. Accordingly, the controller 10, the display section 20, and the touch panel 30 of the image forming apparatus 2 form the display device 1 according to the first embodiment.

The document conveyance section 100 conveys an original document toward the image reading section 110. The image reading section 110 reads an image of the original document and generates image data. The accommodation section 120 accommodates sheets T. The accommodation section 120 includes sheet cassettes 121 and a manual feed tray 123. A stack of sheets T is loaded in each sheet cassette 121. A sheet T is fed from one of the sheet cassettes 121 or the manual feed tray 123 to the conveyance section 130. The sheets T are for example plain paper, copy paper, recycled paper, thin paper, thick paper, glossy paper, or overhead projector (OHP) sheets.

The conveyance section 130 conveys a sheet T toward the image forming section 140. The image forming section 140 includes a photosensitive drum 141, a charger 142, a light exposure section 143, a development section 144, a transfer section 145, a cleaning section 146, and a static eliminating section 147. The image forming section 140 forms (prints) an image on the sheet T.

The sheet T having an image formed thereon is conveyed toward the fixing section 150. The fixing section 150 applies heat and pressure to the sheet T to fix the image to the sheet T. The sheet T having the image fixed thereto is conveyed toward the ejecting section 160. The ejecting section 160 ejects the sheet T.

The storage section 170 includes a main storage device (for example, semiconductor memory) and an auxiliary storage device (for example, a hard disk drive).

The controller 10 controls each element of the image forming apparatus 2. More specifically, the controller 10 controls the display section 20, the document conveyance section 100, the image reading section 110, the accommodation section 120, the conveyance section 130, the image forming section 140, and the fixing section 150 through execution of a computer program stored in the storage section 170. The controller 10 is for example a central processing unit (CPU).

According to the second embodiment, as described above with reference to FIG. 6, the image forming apparatus 2 functions as the display device 1 according to the first embodiment. The second embodiment therefore allows continuous selection of a plurality files as in the first embodiment. Other than that, the second embodiment produces the same effects as the first embodiment.

Through the above, embodiments of the present disclosure have been described with reference to the drawings (FIGS. 1 to 6). However, the present disclosure is not limited to the above embodiments and may be implemented in various different forms that do not deviate from the essence of the present disclosure (for example, variations described below). The drawings schematically illustrate elements of configuration in order to facilitate understanding. Properties of elements of configuration illustrated in the drawings, such as thickness, length, and number thereof, may differ from actual properties thereof in order to facilitate preparation of the drawings. Furthermore, properties of elements of configuration described in the above embodiments, such as shapes and dimensions, are merely examples and are not intended as specific limitations. Various alterations may be made so long as there is no substantial deviation from the effects of the present disclosure.

As described with reference to FIGS. 2A to 4B, an image representing each mode is displayed on the display section 20 to allow a user to recognize the selected mode. Alternatively or additionally, the controller 10 may change a content displayed on the display section 20, for example, a background color displayed on the display section 20 according to the selected mode to allow a user to recognize the selected mode.

What is claimed is:

1. A display device comprising:
a display section having a display surface;
a controller configured to allocate, on the display surface, a plurality of file selection areas in one-to-one correspondence with a plurality of files; and
a detection section configured to detect a position of a touch on the display surface, wherein
the controller selects two or more of the plurality of files corresponding to two or more of the plurality of file selection areas through which the touch has traveled after a specific input is detected.

2. The display device according to claim 1, wherein
the specific input is a touch that is detected within any of the file selection areas and that is stationary for at least a specific period of time.

3. The display device according to claim 1, wherein
the controller further allocates a mode selection area on the display surface, and
the specific input is a touch detected within the mode selection area.

4. The display device according to claim 1, wherein
after the specific input is detected, the controller:
maintains the plurality of files corresponding to the plurality of file selection areas if a touch traveling through any of the file selection areas is detected within the display surface; and
changes the plurality of files corresponding to the plurality of file selection areas if a touch traveling without passing through any of the file selection areas is detected within the display surface.

5. The display device according to claim 1, wherein
the controller causes the display section to display thumbnails of the plurality of files corresponding to the plurality of file selection areas such that each of the thumbnails is superimposed on a region of the display section that corresponds to each of the file selection areas.

6. The display device according to claim 1, wherein
the plurality of files are stored in a folder, and
the controller:
changes the plurality of files corresponding to the plurality of file selection areas upon detection of a touch traveling in a specific direction within the display surface; and
allocates, on the display surface, a folder selection area corresponding to the folder upon detection of a touch traveling in a direction intersecting with the specific direction within the display surface.

7. The display device according to claim 6, wherein
during an initial state prior to detection of the specific input, the controller:
allocates the folder selection area on the display surface; and
causes the display section to display, in a region of the display section that corresponds to the folder selection area, an image representing the folder corresponding to the folder selection area.

8. The display device according to claim 1, wherein
the controller causes the display section to display check marks within regions corresponding to the two or more file selection areas corresponding to the two or more selected files.

9. An image forming apparatus comprising:
the display device according to claim 1; and
an image forming section configured to form an image on a sheet based on the two or more selected files.
